(19) United States
(12) Patent Application Publication
(10) Pub. No.: US 2019/0130499 A1
(43) Pub. Date: May 2, 2019

(54) APPLICATION AND METHOD FOR INTEGRATING SOCIAL MEDIA PLATFORMS

(71) Applicant: Enrico Torres, Coatesville, PA (US)

(72) Inventor: Enrico Torres, Coatesville, PA (US)

(21) Appl. No.: 16/233,145

(22) Filed: Dec. 27, 2018

Related U.S. Application Data
(63) Continuation of application No. 15/087,387, filed on Mar. 31, 2016, now abandoned.
(60) Provisional application No. 62/141,566, filed on Apr. 1, 2015.

(51) Int. Cl. G06Q 50/00; H04M 1/725; H04L 12/58

(52) U.S. Cl. CPC G06Q 50/01; H04M 1/72522; H04M 1/274558; H04M 1/72552; H04L 51/32

(57) ABSTRACT

A method and system for social media interaction on a mobile computing device includes installing an application on the device having a wireless network connection to a host server; selecting the application; logging onto the application to access a home screen; a selection menu with links for selecting features for social media and e-commerce interaction; comments to other users of the application over the network; user preferences; selecting a second user from a list of users associated with a chat function to open a dialogue window between the user and the second user to facilitate direct messaging between the user and the second user; accessing members' profiles with a profile picture and data, and a main feed, that displays information about the member and a selection option to send a request to the respective member to be associated with the user

### CROSS-REFERENCE TO RELATED APPLICATIONS

This application claims the benefit of U.S. Provisional Application No. 62/141,566, filed Apr. 1, 2015, entitled APPLICATION AND METHOD FOR INTEGRATING SOCIAL MEDIA PLATFORMS, which is incorporated herein by reference in its entirety.

### BACKGROUND OF THE INVENTION

The present invention is directed toward an application and a method for integrating social media platforms. More specifically, the present invention is directed to an application and a method for controlling more than one social media platform.

Social media includes an increasing number of platforms for users to connect and stay connected with others. Along with the increasing number of social media platforms, the various platforms are also increasing in complexity. Often, social media users access these various social media platforms with mobile devices, such as phones and/or tablets. However, due to the increasing number and complexity, navigating these social media platforms is becoming increasingly difficult, particularly for those who are not technologically savvy. Additionally, while many social networks are designed to keep users active, individuals are growing discontent with the amount of time required to maintain a presence on multiple platforms at one time.

A system and method with improvements in the process and/or the properties of the components formed would be desirable in the art.

### BRIEF SUMMARY OF THE INVENTION

In one exemplary embodiment, a system is disclosed for providing a social media platform for interaction over a mobile communication network. The system includes a mobile computing device having wireless network connection to a host server. An application is installed on the mobile computing device. The mobile computing device includes a selection icon for selecting the application to activate the application for control of a plurality of features of the mobile computing device. The application includes a secure login feature is for registering a user and permitting access to a home screen associated with the application. A selection menu is accessible through the home screen. The selection menu provides selection links for selecting at from a plurality of features for social media and e-commerce interaction. The plurality of features includes a comments function for sending comments to other users of the application over the mobile communications network. Also, one or more preference functions are included for indicating user preferences associated with a comment, a message or an image. A post function allows the user to transfer a data via the application to a server to facilitate creating, reporting, editing, and deleting data files. A chat selection link opens a chat feature of the application to allow a user to select a second user from a list of users associated with the chat function and open a dialogue window between the user and the second user to facilitate direct messaging between the user and the second user. A profile feature accesses members' profiles stored on the server. The member profiles include a member profile picture and data associated with the respective member. Also a main feed is provided wherein selecting a member profile picture by the user displays information about the member and a selection option to send a request to the respective member to be associated with the user for social media communication.

In another exemplary embodiment, a social media platform for social media interaction over a mobile communication network. The social media platform includes a mobile computing device having an internet connection to a remote server configured to host the application. An application installed on the mobile computing device includes a selection icon for selecting the application to activate the application for control of a plurality of features of the mobile computing device. A secure login feature is provided when launching the application for registering a user and permitting access to a home screen associated with the application. The selection menu includes a home setting tab, to navigate to a home page in response to selecting the home settings tab. A people sharing tab is included to request a function for sending and receiving friend requests from a first user to a second user. A find tab locates other users that are preselected as friends in response to selecting the find tab. A friends tab includes a listing of current friends in response to selecting the friends tab, and a people tab identifies other users not included in the user's friends tab. A location sharing tab is provided for viewing and sharing a user's location. The locations sharing tab associated with a GPS map tracking screen to display a map for sharing current or preselected locations associated with the user; and a URL (Uniform Resource Locator) sharing tab is provided for sharing a URL with another user.

In another embodiment, a method of enabling social media interaction on a mobile computing device includes installing an application on the mobile computing device having a wireless network connection to a host server; selecting the application to activate the application for control of a plurality of features of the mobile computing device; logging onto the application via a secure login feature for registering a user and permitting access to a home screen associated with the application; accessing a selection menu accessible through the home screen; providing selection links for selecting at least one of the plurality of features for social media and e commerce interaction; sending comments to other users of the application over the mobile communications network; indicating user preferences associated with a comment, a message or an image; creating, reporting, editing, and deleting data files; selecting a second user from a list of users associated with the chat function, and open a dialogue window between the user and the second user to facilitate direct messaging between the user and the second user; accessing at least one members' profiles stored on the server, the member profiles comprising a member profile picture and data associated with the respective member; and a main feed, wherein selecting a member profile picture by the user displays information about the member and a selection option to send a request to the respective member to be associated with the user for social media communication.

An advantage of the present invention is the integration of multiple features and functions of a smartphone or other portable device through a single social media application that simplifies and streamlines use of the smartphone or device for social media users.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE SEVERAL VIEWS OF THE DRAWING

FIG. 1 is an image of an exemplary application screen displayed on a smart phone screen.

FIG. 2 is an image of a home page according to an embodiment of the disclosure.

FIG. 3 is an image of a comment box according to an embodiment of the disclosure.

FIG. 4 shows a members profile according to an embodiment of the disclosure.

FIG. 5 shows an interests tab from an application programming interface (API) according to an embodiment of the disclosure.

FIG. 6 shows a timeline view according to an embodiment of the disclosure

FIG. 7 shows a display of stored image files, or pictures, from a camera on the portable device

FIG. 8 shows a live broadcast display according to an embodiment of the disclosure.

FIG. 9 shows a live broadcast preference screen for user selections.

FIG. 10 shows a broadcast video screen.

FIG. 11 shows a favorites folder with images and titles.

FIG. 12 shows a friends tab according to an embodiment of the disclosure.

FIG. 13 shows a people tab according to an embodiment of the disclosure.

FIG. 14 shows a messages tab according to an embodiment of the disclosure.

FIG. 15 shows a notifications tab according to an embodiment of the disclosure.

FIG. 16 shows a locations tab according to an embodiment of the disclosure.

FIG. 17 shows a sharing URLs dialogue box according to an embodiment of the disclosure.

FIG. 18 shows a screen shot of a mere aiding feature according to an embodiment of the disclosure.

FIG. 19 shows a screen shot of a graphical user interface arranged in a segmented wheel- or pie-shape according to an alternate embodiment of the disclosure.

FIG. 20 shows an exemplary flow chart of the operation of the home page.

Wherever possible, the same reference numbers grill be used throughout the drawings to represent the same parts.

### DETAILED DESCRIPTION OF THE INVENTION

Provided are a social medial application (hereinafter referred to as “the application”), and a method for integrating multiple social media platforms. Embodiments of the present disclosure, in comparison to applications and methods not using one or more of the features disclosed herein, provide an ability to simultaneously monitor multiple social media platforms, provide an ability to simultaneously control multiple social media platforms, decrease social media navigation complexity, decrease a difficulty associated with navigating various social media platforms, decrease the time required to interact with multiple social media platforms, provide an ability to monitor time spent interacting on social media, or a combination thereof.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

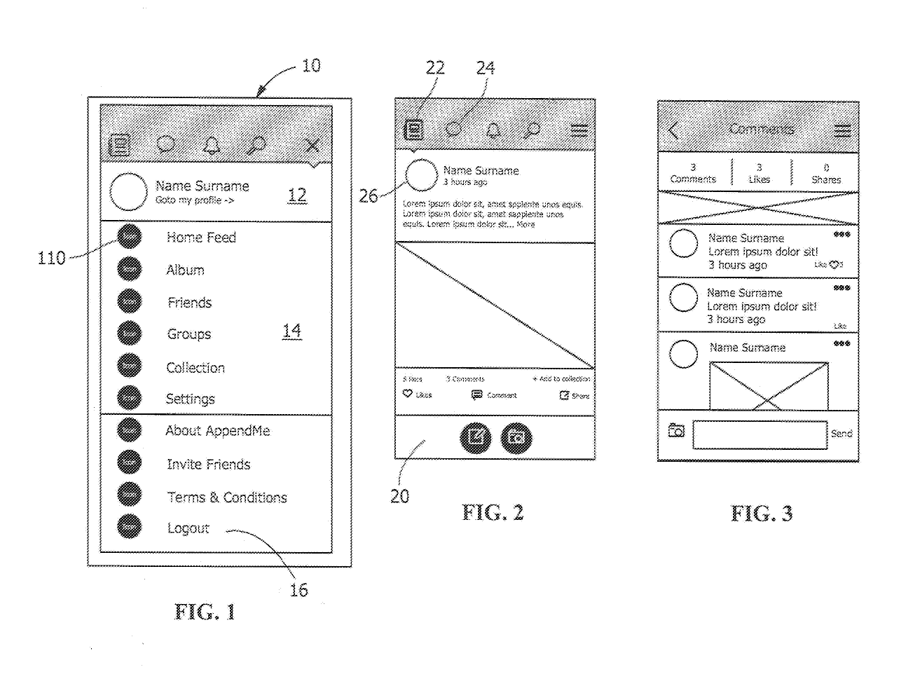

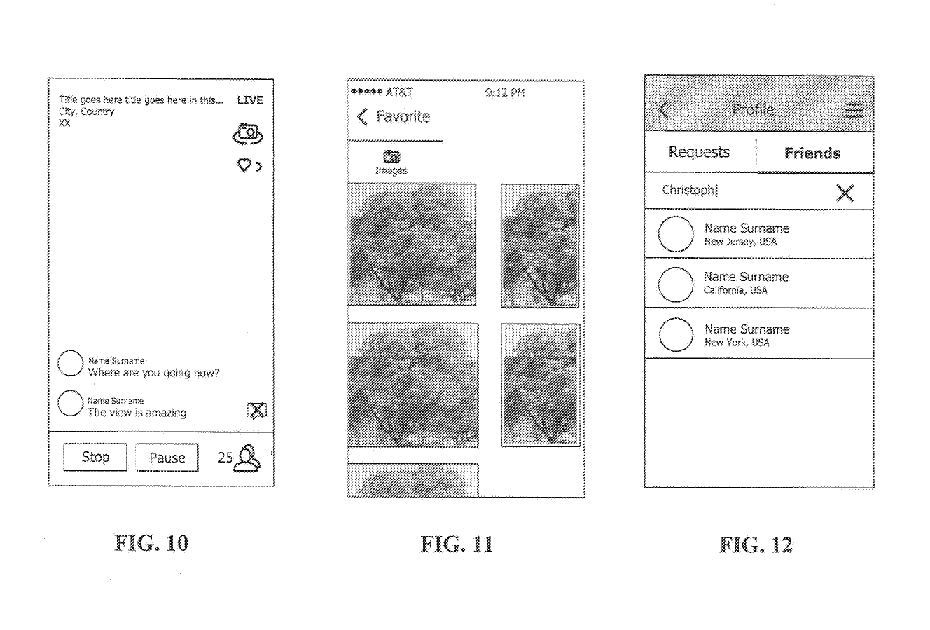

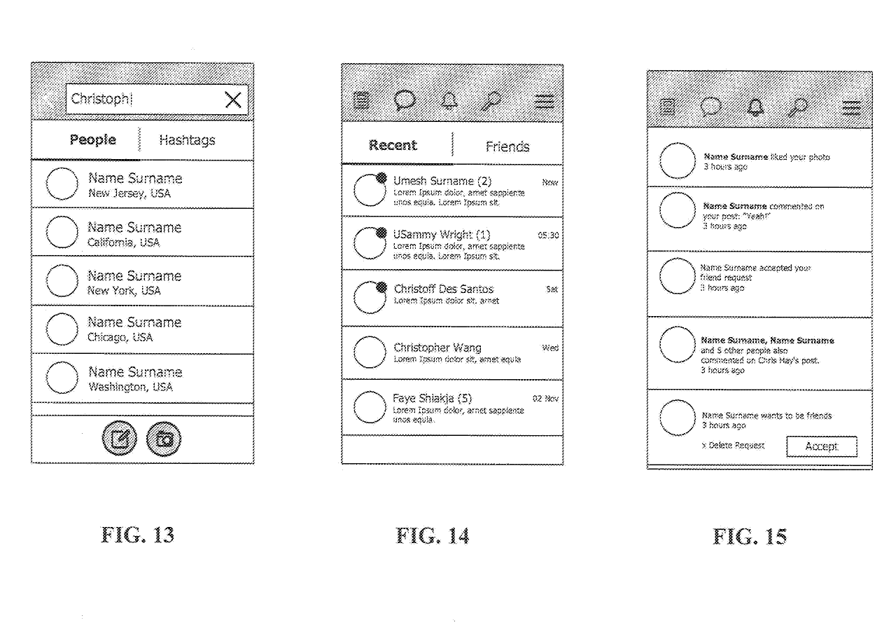

Referring to FIGS. 1-20, in one embodiment, an application provides a user interface for social media interaction. The application may be used with any suitable device having an internet connection to a remote server configured to host the application. Suitable devices include mobile devices, such as, but not limited to, smart phones, tablets, portable computers, or a combination thereof. For example, the application may be configured for use with an iPhone, an Android phone, or a website/web service. In another example, the applications include the following parameters:

In an iPhone App:
Language: Objective C, (native)
Development Tool: Xcode 6.1+
OS Support: iOS7, iOS8
Device Support: iPhone 4s, 5, 5s, 6, 6+

Android App
Language: Java, Android SDK
Development Tool: Eclipse, Android Studio
OS Support: 4.0+

Website/Web services
Language: PHP/MySQL, AJAX, JQuery, HTML5, CSS3
Browser support: Mozilla, Safari, Google Chrome
API Development: REST API with JSON

Additionally, the application may be configured for use on non-mobile devices, such as desktop computers. In another embodiment the application is configured to simultaneously monitor or control one or more social media platforms. Simultaneously monitoring and/or controlling one or more social media platforms with the application decreases an amount of time and difficulty involved with navigating multiple platforms.

In one exemplary embodiment, a user may download and install the application. Referring to FIG. 1. An icon or logo 12 may be displayed on a home screen of a smart phone or other mobile device 10. When a user selects an icon associated with the application, a splash screen may be displayed, e.g., a logo representing the application provider, followed by a sign up page for the user to subscribe to the social media application, a log in page 14 for registered users to securely access the application, or a home page with navigation functions or menus. For example, in one embodiment, the sign up page is displayed each time the application is opened, and includes an option for new users to sign up or for existing users to log in. Alternatively, the sign up page is displayed the first time the application is opened, and subsequent opening of the application proceeds directly from the splash screen to the log in page. The log in page 14 may also include an option 16 for new users to proceed to the sign up page. In another alternate embodiment, once a user has logged in, selecting the icon will display the splash screen and then proceed directly to the home page (FIG. 2) without displaying either the sign up page or the log in page. In a further embodiment, after the smart phone or other device is reset, selecting the icon will display the log in page instead of proceeding directly from the splash screen to the home page.

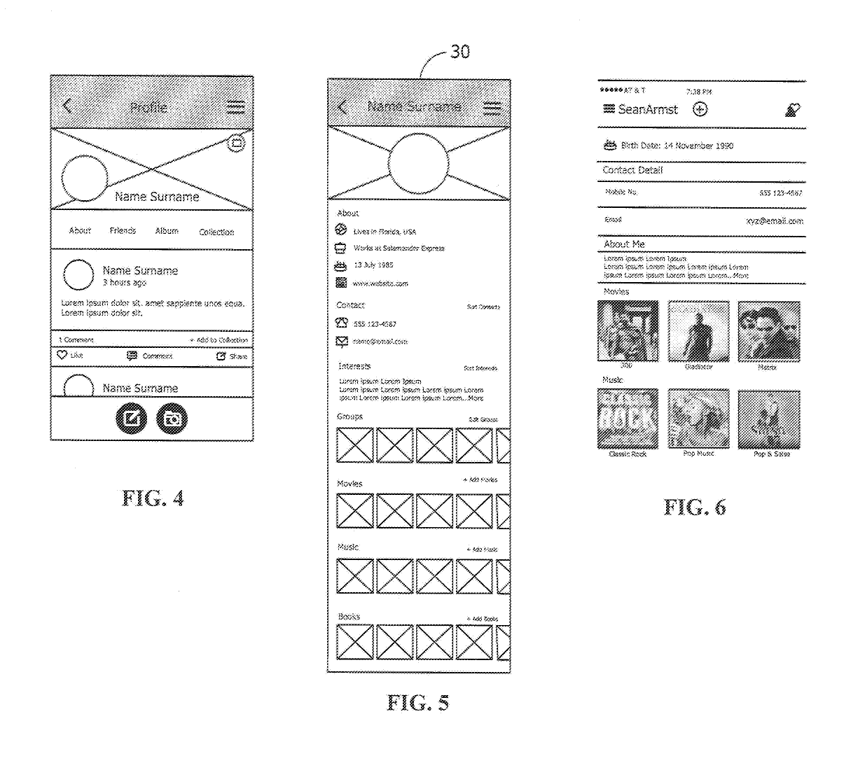

Once a user has signed up or logged in to the application, a home page is displayed on the device screen (FIG. 2). The home page provides a user with a menu 22 including various options for social media and e-commerce interaction. For example, in one embodiment, the home page menu provides a user with access to a comments function for sending comments to other user, like and dislike functions for indicating user preferences, and post functions to allow the user to upload the messages. In another embodiment, the posts function facilitates creating, reporting, editing, and/or deleting a post. Additionally, the home page includes a chat option 24 that opens a chat function (FIG. 14). When a user selects another user from the chat function, a dialogue window is opened between the users to facilitate direct messaging. The home page also provides access to members' profile pictures 26 and a main feed. Clicking on a member profile picture displays information about that member and/or provides an option to request friendship (FIG. 4). Selecting an image from the main feed, such as by double clicking on the image, displays information on the image (FIG. 5) and/or facilitates zooming in and/or out of the image.

Referring to FIG. 2, a menu option 22 on the home page 20 opens a menu bar which provides access to various features within the application. For example, in one embodiment, the menu bar provides access to the home feed, a user profile page, a photos, or album, page to access photographs and videos, a settings page for privacy and other personal preference configuration, a feedback/report issues page for the user to communicate with the application administrator, a terms and policies page for users to view the terms and policies associated with the application, and a log out option that enables the user to exit the application. Referring to FIG. 5 the user profile page 30 includes an application programming interface (API) that provides access to images for the user profile, facilitates zooming on photos, deleting, reporting, editing, commenting, liking, and/or disliking photos and other content, and optionally displays a user timeline (FIG. 6). The user profile page 30 also provides the user with options to report spam, send and receive instant messages, message friends, and/or request friendships. The privacy settings page provides the user with access to profile settings, items settings, notifications settings, blocked users settings, and an option for enabling an invisible mode, which allows the user to initiate an active session without other users detecting that the user is online. The notifications settings are provided to customize the actions and events for which notifications are generated by the application.

The home screen 20 includes an interaction button that provides access to a selection menu. In one embodiment, the selection, menu 101 may be in the form of a segmented wheel 1 (FIG. 19), with each wheel segment representing a different selection element for selecting from a plurality of device functions from within the application. For example selecting the interaction button, which may include a plus sign located in the center of an upper portion of the screen, displays the selection menu 101. Although shown as a plus sign in the figure, as will be appreciated by those skilled in the art, the selection menu may be in the shape of a wheel or any other suitable shape, design, or location. The selection menu provides an intuitive layout, which allows those less technologically skilled to more easily connect through social media while also providing faster social media interaction.

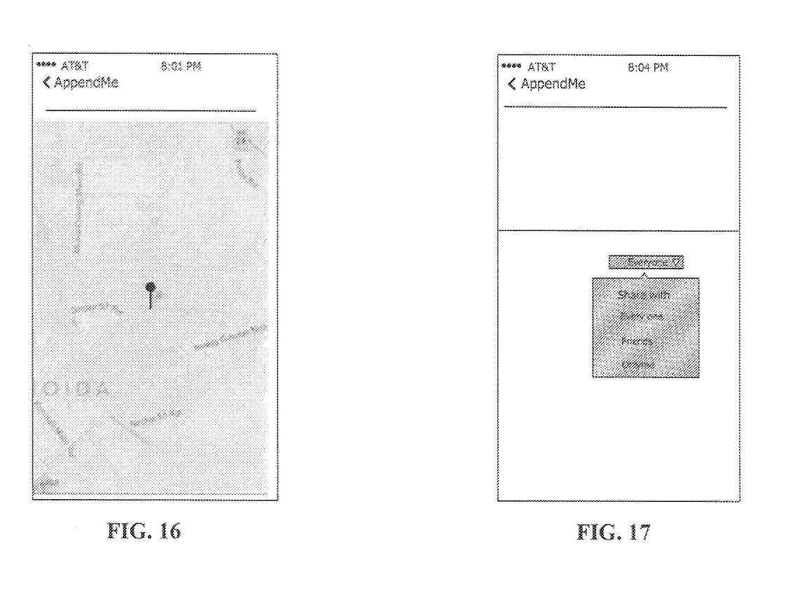

As illustrated in FIG. 19 in one embodiment, the selection menu 101 includes a home setting tab 110, which returns the user to the home page 10 a people sharing tab 112, a messages sharing tab 114, a notifications sharing tab 116, a locations sharing tab 118, a URL (Uniform Resource Locator) sharing tab 120, an images sharing tab 122, a text sharing tab 124, a camera sharing, tab 126, a timer setting tab 128, and a favorite albums tab 130. Selecting the people tab 112 provides a user with access to requests function for sending and receiving friend requests, find friends function for locating other users that are friends, friends function for a listing of current friends, and people for identifying users other than current friends. Selecting the messages tab 114 displays a user's messages and provides an option to start messaging. Selecting the notifications tab 116 displays a notifications screen (FIG. 15). Selecting the locations tab 118 displays a location screen for viewing and/or sharing a user's location. Additionally, a GPS map tracking screen (FIG. 16) displays a map for sharing locations on the home page or on the profile timeline (FIG. 6). Selecting the URL tab 120 displays a URLs screen, which facilitates adding videos sharing videos on the home page, and watching videos on the user's profile page.

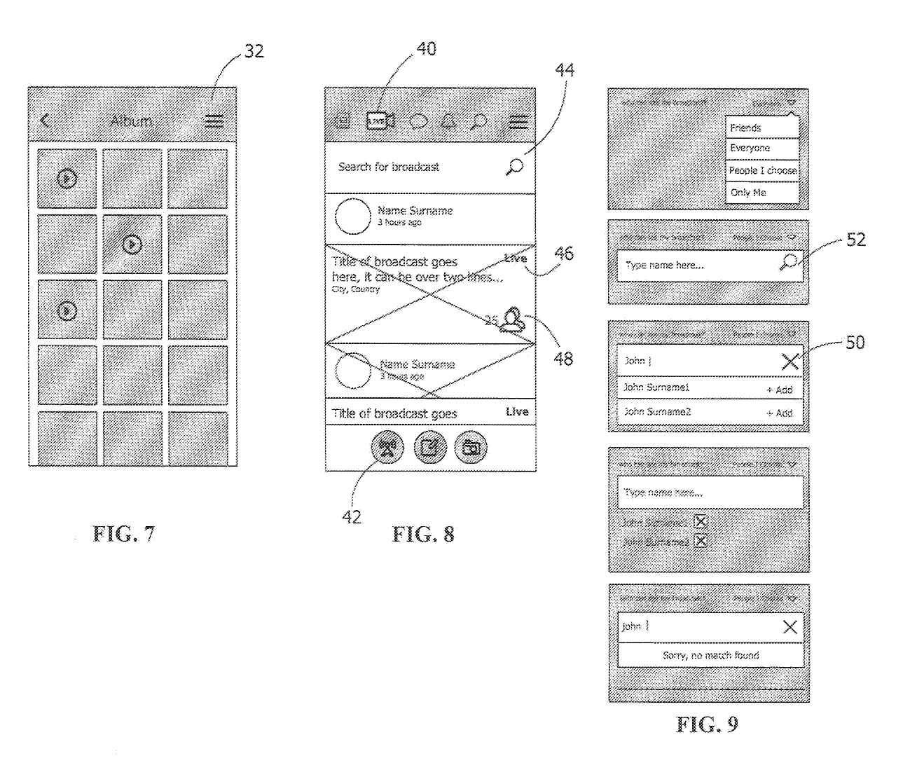

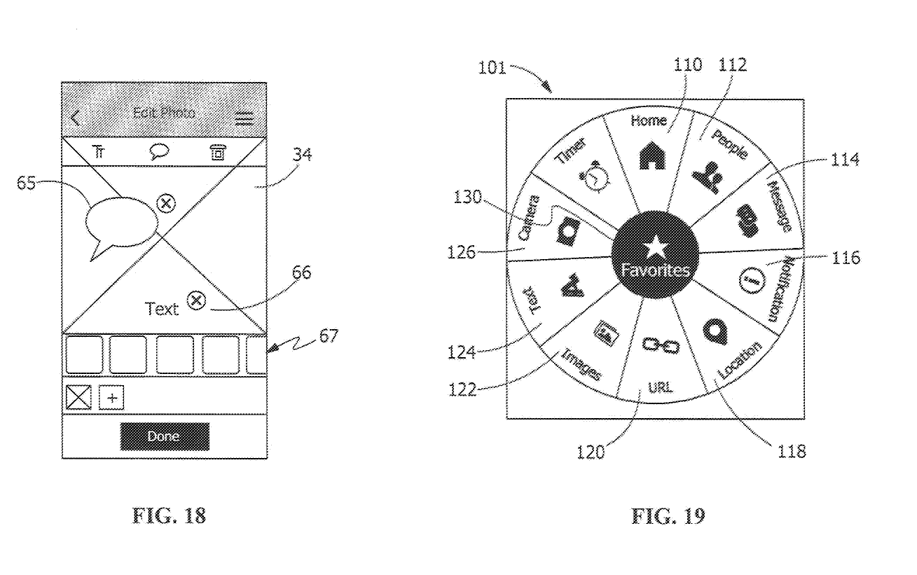

Referring to FIG. 19, selecting the images tab 122 provides a user with options for selecting, editing, and/or sharing images in the home page 10 and/or the profile timeline (FIG. 6). For example, in one embodiment, when the images tab 122 is selected the application displays a list of options for selecting and/or sharing one or more images. As illustrated in FIG. 7, in another embodiment, the list of options includes multiple images on one frame or image(s) and text. After selecting and option from the list of options, the user selects one or more images from the camera roll or Album 32 (FIG. 7). Once an image is selected, the user has the option to crop the image, add a memo 34 (FIG. 18), add text, add a filter, or share a final product on the user timeline (FIG. 6) or the home page (FIG. 1). In a further embodiment, when the frame option is selected from the list of options, a user is provided with various frames into which figures may be inserted. After selecting a frame, the user selects a location to obtain pictures and selects the pictures (e.g., from the camera roll). The selected images are then displayed on the frame and the user may select a background pattern, a background color, a photograph or frame shape, and optionally add text. The application also facilitates saving collages or multiple photographs in a single frame to the camera roll, changing or filtering of the images, or sharing of the images on the home page 10 or the profile timeline (FIG. 6). For example, the application may automatically save any picture created and/or posted by a user.

When the user selects the text sharing tab 124, the application displays a text screen. From the text screen, the user enters text and shares the entered text on the home page and/or the profile timeline, Selecting the camera tab 126 from the selection menu 101 displays a camera screen, which facilitates image cropping, adding mere text 65 and/or filters to an image, adding text on the camera screen 66, adding filters on the camera screen 67. After cropping, adding incline text, image text, and/or filters the image is displayed in a final image to share screen (FIG. 68), from which the modified image is saved and/or shared to the home page 10 and/or the profile timeline (FIG. 6).

The timer tab 128 on the selection menu 101 provides access to a timer function in the application. In one embodiment the timer feature permits a user to set reminders within the application. A reminder note may be selected from a pre-set list of notes or customized to display a personal message. The reminder note may then be displayed at a predetermined time or after a predetermined interval which is selected by the user. In another embodiment, the timer function includes a stopwatch to record the time interval that the application has been open, providing a user with a record of how much time they are spending interacting with social media. In a further embodiment, the timer feature provides increased control over time spent using social media and/or decreases total time spent using social media.

The favorite tab 130, shown in the center of the wheel 101 in FIG. 19, provides access to customizable albums containing user's favorite images. In one embodiment, an icon, such as a star, is displayed on each post in the main page 10 and/or the profile timeline (FIG. 6). Selecting the favorites icon 130 provides a drop down menu with options relating to the post. In the drop down menu the user is provided with an option to add the post to a favorites folder. Once added to a favorites folder, the post is accessible from the favorites tab 130 which displays a folder including images and text describing each folder. Selecting one of the folders within the favorites folder displays a second folder including the selected images.

The application may also include a video feature for adding and/or sharing personal videos. For example, using the personal video feature, users are able to record and/or share videos of up to 16 seconds or greater in duration. In one embodiment, the video feature provides multi video chatting anywhere in the world. With unlimited messaging, the application simplifies user's lives by providing multiple communication features in one place. Other features may include a radio, retail stores that provide users with an ability to sell items and make purchases within the application (e.g., for services such as roofing, plumbing, taxi, etc.), a music feature for creating albums, purchasing music, and/or playing music, and/or a database of companies, distributors, and/or service providers that users can rate, review and contact.

In an exemplary embodiment, a live broadcast function may be integrated with the application and the video function of the smartphone. Referring to FIG. 8-10 the application may include a live broadcast selection button 40. After launching the live broadcast function the user may select a broadcasting button 42 to commence a live broadcast, select the content and the authorized viewers (i.e., public to all members, selected friends, or other demarcation). A search facility 44 enables a user to search for broadcasts based on names or “hashtags”. The user receives an indication 46 that the video is live and the number of people 48 viewing this broadcast, as shown in FIG. 8. The broadcast function provides an invitation window 80 for the user to determine other users who can view the broadcast. A search window 52 is provided for the user to search contacts for people permitted to view the broadcast and a listing of the names selected. A clock may be associated with the broadcast function to time the broadcast or execute a countdown sequence to go live, along with stop and pause buttons that allow the user to selectively interrupt the broadcast temporarily. The live broadcast function allows the application to broadcast events, e.g., breaking news, directly to the Internet in real time without having to save the video for uploading at a later time, and without having to exit the application to launch a separate feature on the smart phone or portable communications device.

In one embodiment, setting up the application includes downloading the application, logging in to the application, and creating a profile page. Creating the profile page includes, but is not limited to, providing interests and personal information relating to the user. After creating the profile page, the features described herein are accessible to the user, facilitating posting and sharing links, videos, pictures, multiple images, instant messaging, requesting friends, posting blogs, creating business pages, etc., all in an easy to use application. In another embodiment, the selection menu 101 keeps all functionalities easy to access, and facilitates easy sharing of content, such as pictures, along with picture filtering, adding text to pictures, and create collages. The user can select any option available on the application and use it accordingly to post and share whatever it is that they want to post or share. The application host or administration may establish guidelines for users to prevent the use, publication or distribution of offensive content. In a further embodiment, the application includes software configured to learn the patterns of each member, and make suggestions for friends, places, and/or sponsored ads. Together, the features of the application described herein enhance the users experience without infringing on their personal information.

In one embodiment, a method of using the application includes accessing the home page, accessing the menu tab, and/or accessing the selection menu 101. Accessing the home page provides the user with an ability to like, comment, share, dislike, edit, delete, report, instant message, zoom in on images, message people, and/or request friendships. In another embodiment, accessing the menu tab provides a user with access to a profile page, a photos page, a privacy page, a report issues button, a terms and policies button, a log out button, and a home button which returns the user to the home page. The profile page provides the user with a fully customizable page having the ability to drag the user's profile picture to a desired location, add a different background pictures, add personal interests, add movies, and/or add music. Additionally, the profile page provides the user with API (application programming interface) and an images page where all the images the user has loaded are saved with their respective details. The profile page also includes a personalized timeline that displays items the user has posted and/or that the user's friends have shared. The photos page displays images that that the user has taken with the built in camera feature. The privacy button provides the user with an easy to read screen on how to set up user profiles, items, notifications, blocked users, and selecting invisible mode. The report issues button provides the user with the ability to contact the developers with feedback and/or concerns, and the terms and policies button displays a digital copy of the terms and policies.

From the home page, the user is able to select the plus sign, which displays the selection menu 1 on the screen. The displaying of the selection menu 101 includes, but is not limited to, the selection menu 1 appearing from the bottom of the screen, the selection menu 101 expanding from the plus sign, the wheel opening in a clockwise or counterclockwise manner on the screen, or a combination thereof. Once the selection menu 101 is displayed on the screen, the selection menu 1 may be rotated to show additional tabs corresponding to additional features such as, but not limited to, music, videos, and/or stores tabs. The selection menu 101 includes various features for staying connected with other users. For example, clicking on the people tab displays friend suggestions, which are based on the user's interests. An algorithm in the application selects people with similar interests for the user to follow, and if desired, send a friend request. The user is also able to receive friend requests from other users who like what they see and want to become friends with the user. The friends tab displays all of the user's friends and people, these are random people from all over the world that you can see assuming they've made their profile public. In the messages tab the user is able to see who sent them messages and also reply to the messages. Additionally, the notifications tab informs the user if anyone liked, disliked or commented on something of theirs. The locations tab allows the user to pick places, assuming that the user allows the application to enter the GPS function of their mobile device, which allows the user to share their statuses quicker. In the URLs tab the user cuts and pastes message with a URL, and shares them with the other users.

To load images, the user may select the images icon on the selection menu 1, which will display a screen allowing the user to choose image(s) and/or text. In certain embodiment, such as, for example, in a slide mode, the user may also select up to 5 or more pictures and crop them if desired, add text, memos, filters, and then preview their work, save it to their mobile device library, and/or share it with some or all of the other users. The user is also able to select multiple images on one frame by clicking on the images tab and selecting the frame option described herein. The user then selects a frame along with up to 5 or more pictures, optionally crops the images, zoom in, filter the images, adds a patterned background on frame or solid colors, selects a rounded frame or individual pictures, filters each individual image, and/or changes the images before or after saving their creations to the camera roll. To add text, the user selects the text tab from the selection menu 101 and enters the text they wish to share. From the camera icon the user is able to take pictures of things and people as well as themselves while also using the built in timer. By using the built in timer, users are able to take pictures of themselves without relying on someone else. Once the user has taken a picture, the application provides them with the ability to crop the image, add text, filter the image, and/or post the image. It should be noted that the terms picture, image, image file and photograph are used interchangeably throughout the specification, and may also include video, video files, and broadcast content.

The application also includes the timer feature, which is accessible from the selection menu 1. The timer was created to help people stay connected to reality and still get their social media needs in. The timer is fully customizable with personalized messages in case a user does not like the preset messages. Additionally, the timer includes the ability to add customized time intervals from 1 minute to 12 hours. To return to the home, page the user may click on the home button or simply click anywhere outside the wheel. By using all the tools available on the application the user will find it very easy to stay connected.

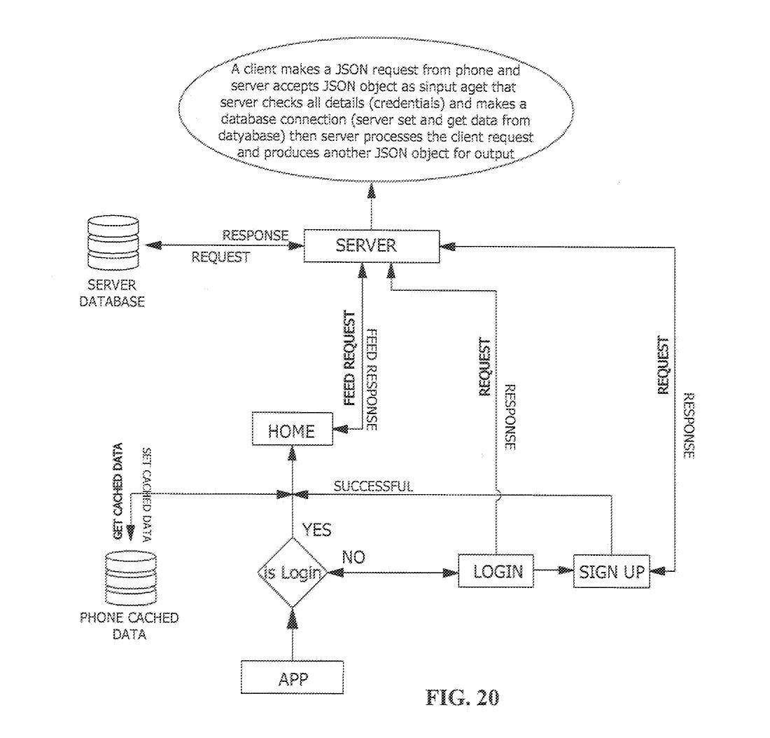

Referring next to FIG. 20, an exemplary flow chart of the operation of the home page is shown. When the application is initialized the system determines at step 201 whether the user is logged in to the application. In response to the determination that the user has already logged in, the application proceeds at step 202 to cache data and fetch the data if there is any record of feed data and displays the data on the home page, while in the background the application communicates with the server to fetch new or updated feed records. At step 203 if a user is not logged in then the Login Page is displayed so that the user can login or register as a new user. At step 204 if the user is already registered in the application then user completes the login credentials and submits a request to the server to authenticate the user's credentials. If user is authenticated then the system retrieves the login data from the response and sends it to the cached database, then proceeds to step 202.

If user is not registered then the system proceeds to step 205 to the signup page and submits the details necessary to register and requests to the server to register the new user. If the response of step 205 is successful then at step 206 the system retrieves the user data from response and caches the data. A client makes a (Java Script Object Notation) JSON request from the smart phone and the server accepts the JSON objects as input after validating the user's credentials, and connects to the database (server set and get data from database). Then the server processes the client request and produces another ISDN object for output to the user's smart phone. The system then returns to step 202.

Once the application has been downloaded and installed the user will appreciate that they have many tools available and they no longer need to have multiple accounts for their social media recreation. The application provides a very clean and simple interface, which includes the selection menu 1 that provides users with the ability to post anything in seconds. This eliminates confusion for anyone, especially the older generation that only uses social media on their computer because it is currently too difficult for them to use social media on mobile devices. The timer provides a useful tool for monitoring and/or controlling time spent on social media in a day in age where people are spending significant amounts of time on social media. The timer is customizable, which provides a more enjoyable experience for users of the application. For example, the application facilitates quick, easy, and controlled social media interaction while allowing time for other activities. By using the application described herein, users may coexist with social media technology without letting it run their lives.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for providing a social media platform for interaction over a mobile communication network comprising:
a mobile computing device having wireless network connection to a host server;
an application installed on the mobile computing device, the application comprising:
a selection icon for selecting the application to activate the application for control of a plurality of features of the mobile computing device;
a secure login feature for registering a user and permitting access to a home screen associated with the application;
a selection menu accessible through the home screen, the selection menu providing selection links for selecting at least one of the plurality of features for social media and e-commerce interaction;
wherein the plurality of features includes a comments function for sending comments to other users of the application over the mobile communications network;
one or more functions for indicating user preferences associated with a comment, a message or an image;
a post function to allow the user to transfer a data tile to a server to facilitate creating, reporting, editing, and deleting data files;
a chat feature to opens a chat feature to allow a user to select a second user from a list of users associated with the chat function and open a dialogue window between the user and the second user to facilitate direct messaging between the user and the second user;
a profile feature to access at least one member& profiles stored on the server, the member profiles comprising a member profile picture and data associated with the respective member; and a main feed, wherein selecting a member profile picture by the user displays information about the member and a selection option to send a request to the respective member to be associated with the user for social media communication.

2. The system of claim 1, further comprising a selection means to select an image from the main feed, and a zoom function.

3. The system of claim 1, wherein the user profile page includes an application programming interface (API) that provides access to images for the user profile.

4. The system of claim 1, further comprising features for deleting, reporting, editing, commenting, liking, and/or disliking photos and other content.

5. The system of claim 1, further comprising a selection link to a timer feature to display a timeline indicating a user's activity and locations.

6. The system of claim 1, further comprising a selection link to a messaging feature, the messaging feature configured to allow a user to send and receive instant messages, message friends, and request friendships.

7. The system of claim 1, wherein the profile feature comprises a privacy settings page to access and configure settings associated with the user, items, notifications, and blocked users.

8. The system of claim 1, further comprising a selection link for selecting an invisible mode to initiate an active user session wherein the user is not detectable online by other users.

9. The system of claim 1, further comprising a selection link to a notifications feature, wherein settings for the notification are provided to customize actions and events for which notifications to the user are generated by the application.

10. The system of claim 1, further comprising a selection link to a feedback feature for the user to communicate with the application administrator and report on issues associated with the application.

11. The system of claim 1, further comprising a broadcasting feature for transmitting live video to other users.

12. The system of claim 1, further comprising a hosting server for storing user data associated with each feature of the plurality of features.

13. A social media platform for social media interaction over a mobile communication network comprising:
a mobile computing device having an internet connection to a remote server configured to host the application;
an application installed on the mobile computing device, the application comprising:
a selection icon for selecting the application to activate the application for control of a plurality of features of the mobile computing device;
a secure login feature for registering a user and permitting access to a home screen associated with the application;
the selection menu comprising
a home setting tab, to navigate to a home page in response to selecting the home settings tab;
a people sharing tab to requests function for sending and receiving friend requests from a first user to other user, a find tab for locating other users that are preselected as friends in response to selecting the find tab, a friends tab for a listing of current friends in response to selecting the friends tab, and a people tab for identifying users not included in the user's friends tab;
a locations sharing tab, for viewing and sharing a user's location, the locations sharing tab associated with a GPS map tracking screen to display a map for sharing current or preselected locations associated with the user; and
a URL (Uniform Resource Locator) sharing tab for sharing a URI with another user.

14. The platform of claim 13, wherein the selection menu further comprises a messages sharing tab to display a user's messages and provide an option to start messaging.

15. The platform of claim 13, wherein the selection menu further comprises a notifications sharing tab to display a notifications screen in response to selecting the notifications sharing tab, the notifications screen configured to display one or more incoming messages and status indicators to the use.

16. The platform of claim 13, wherein the selection menu further comprises an images sharing tab, the images sharing tab configured to provide options for selecting, editing, and sharing images.

17. The platform of claim 13, wherein the selection menu further comprises a text sharing tab to display a text screen in response to selecting the text sharing tab, the text screen configured to enter text and share the entered text on one of the home page and the timeline.

18. The platform of claim 13, wherein the selection menu further comprises a camera sharing tab to display a camera feature integrated within the mobile device, the camera feature configured to edit an image and display the edited image in a final image to a share screen from which the edited image is saved or shared to the home page or the timeline.

19. A method of enabling social media interaction on a mobile computing device comprising;
installing an application on the mobile computing device having a wireless network connection to a host server;
selecting the application to activate the application for control of a plurality of features of the mobile computing device;
logging onto the application via a secure login feature for registering a user and permitting access to a home screen associated with the application;
accessing a selection menu accessible through the home screen,
providing selection links for selecting at least one of the plurality of features for social media and e-commerce interaction;
sending comments to other users of the application over the mobile communications network;
indicating user preferences associated with a comment, a message or an image;
creating, reporting, editing, and deleting data files;
selecting a second user from a list of users associated with the chat function and open a dialogue window between the user and the second user to facilitate direct messaging between the user and the second user;
accessing at least one members' profiles stored on the server, the member profiles comprising a member profile picture and data associated with the respective member; and a main feed, wherein selecting a member profile picture by the user displays information about the member and a selection option to send a request to the respective member to be associated with the user for social media communication.

20. The method of claim 19, further comprising the step of:
transmitting a live video broadcast to other users.
